(19) United States
(12) Patent Application Publication
(10) Pub. No.: US 2021/0181823 A1
(43) Pub. Date: Jun. 17, 2021

(54) PROACTIVE CONTROL OF ELECTRONIC DEVICE COOLING

(71) Applicant: Lenovo (Singapore) Pte. Ltd., Singapore (SG)

(72) Inventors: Bryan Loyd Young, Tualatin, OR (US); William Fred Martin-Otto, Wimauma, FL (US); Timothy Samuel Farrow, Cary, NC (US); Marc Richard Pamley, Apex, NC (US)

(21) Appl. No.: 17/188,503

(22) Filed: Mar. 1, 2021

Related U.S. Application Data
(63) Continuation-in-part of application No. 14/815,043, filed on Jul. 31, 2015.

(51) Int. Cl. G06F 1/20; G06F 1/16; G06F 1/3206

(52) U.S. Cl. CPC G06F 1/206; G06F 1/3206; G06F 1/1635

(57) ABSTRACT

One embodiment provides a method, including: obtaining, using at least one sensor, a value related to a current overall power consumption for an electronic device; calculating, using a processor, a forecasted heat value calculated from the current overall power consumption, wherein the forecasted heat value indicates an expected value of heat for a region of the electronic device, wherein the calculating comprises correlating the current overall power consumption to a forecasted heat value; and proactively cooling, based upon a fan control algorithm, the electronic device prior to a sensor detecting a temperature corresponding to the expected value of heat, wherein the proactively cooling comprises adjusting a speed of one or more fans located within the electronic device based on the calculated heat value.

### CROSS-REFERENCE TO RELATED APPLICATIONS

This application is a continuation-in-part of U.S. patent application Ser. No. 14/815,043, entitled “PROACTIVE CONTROL OF ELECTRONIC DEVICE COOLING,” filed on Jul. 31, 2015, the contents of which are incorporated by reference herein.

### BACKGROUND

Electronic devices (e.g., servers, work stations, desktops, laptops and other devices) generate heat due to their use of electricity. Typically a leading heat generating component is a processor (e.g., CPU, GPU, etc.). Other components, however, also generate heat that must be removed from the system, such as a battery pack

For removing heat, inductive (e.g., drawing heat away from the components into a heat sink) and convective cooling are applied, e.g., fan(s) are spun to remove hot air from the system or device case. Cooling systems are typically distributed throughout the electronic device, e.g., motherboard, battery pack, etc. Thermistors in these locations determine the current temperature of the internal component, which reactively provides heat data for the cooling system to control fan speeds. The fans at different locations speed up and slow down at different rates and times, i.e., in a reactive fashion that depends on the locally sensed heat.

Users tend to notice that fans make noise. Typically what users notice, however, is not necessarily just the overall noise that fans make, but the frequent changes in noise caused by raising and lowering the fan speed.

### BRIEF SUMMARY

In summary, one aspect provides a method, comprising: obtaining, using at least one sensor, a value related to a current overall power consumption for an electronic device; calculating, using a processor, a forecasted heat value calculated from the current overall power consumption, wherein the forecasted heat value indicates an expected value of heat for a region of the electronic device, wherein the calculating comprises correlating the current overall power consumption to a forecasted heat value; and proactively cooling, based upon a fan control algorithm, the electronic device prior to a sensor detecting a temperature corresponding to the expected value of heat, wherein the proactively cooling comprises adjusting a speed of one or more fans located within the electronic device based on the calculated heat value.

Another aspect provides a device, comprising: a fan that moves cooling air; a processor operatively coupled to the fan; a memory device that stores instructions executable by the processor to: obtain, using at least one sensor, a value related to a current overall power consumption for an electronic device; calculate, using a processor, a forecasted heat value calculated from the current overall power consumption, wherein the forecasted heat value indicates an expected value of heat for a region of the electronic device, wherein the calculating comprises correlating the current overall power consumption to a forecasted heat value; and proactively cool, based upon a fan control algorithm, the electronic device prior to a sensor detecting a temperature corresponding to the expected value of heat, wherein the proactively cooling comprises adjusting a speed of one or more fans located within the electronic device based on the calculated heat value.

A further aspect provides a product, comprising: a storage device having code stored therewith, the code being executable by a processor and comprising: code that obtains, using at least one sensor, a value related to a current overall power consumption for an electronic device; code that calculates, using a processor, a forecasted heat value calculated from the current overall power consumption, wherein the forecasted heat value indicates an expected value of heat for a region of the electronic device, wherein the calculating comprises correlating the current overall power consumption to a forecasted heat value; and code that proactively cools, based upon a fan control algorithm, the electronic device prior to a sensor detecting a temperature corresponding to the expected value of heat, wherein the proactively cooling comprises adjusting a speed of one or more fans located within the electronic device based on the calculated heat value.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates an example method of proactive control of electronic device cooling using power consumption data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Fans are an integral part of cooling certain electronic devices. Since fans make noise based on their rotational movement, the slower they spin, the less noise they make. Additionally, fans that frequently transition or change their rotational speeds tend to produce a noise pattern that the user notices over and above the overall noise that the fans make. In traditional closed-loop thermal control systems, the cooling (fans) may be controlled by means of recording data from various thermal sensors in the system, and adjusting the fan speeds accordingly. Given the thermal characteristics of a system, there may always be a lag of temperature rise to real power usage, and to account for this, fan control must be more conservative (i.e. typically must spin faster and longer) to account for worst case temperature conditions. In other words, conventionally fans are controlled reactively in response to sensed heat, e.g., as sensed by thermistor readings and the system management chip. Thus, the fan speed is delayed based on the thermal capacitance of the particular system element(s). This means that by the time the heat is sensed and the fans are instructed to speed up to reduce system heat, the heat has already been added to the system. This delay for capacitance means that fans also do not slow down again until the heat is fully dissipated, again due to a heat capacitance issue.

Compounding the issue is the fact that fans are not smoothly controlled. Rather, fans tend to step their speeds up and down incrementally in response to sensed heat. That is, a fan may be controlled to step up its speed for a predetermined time in response to a sensed heat value. The fan will not step its speed back down until expiration of the time. Fan control functions are often a matter of manual tuning to achieve adequate heat removal with acceptable noise levels.

Accordingly, an embodiment proactively controls the fan(s) by taking into account the power being consumed by the system rather than strictly by the heat being generated by the system. For example, in an embodiment, based on component heat capacity, power usage and ambient temperature, an embodiment may calculate the air movement necessary to remove the heat from the system prior to the heat being generated and absorbed by the system.

A supplemental calculation may be used to smooth the effects of raising and lowering the fan speed, thereby reducing the overall acoustic impact of the system and maintaining a steadier acoustic volume with fewer variations. By smoothing out the changes in fan speed proactively based on the power consumption data, an embodiment can raise the rotational speed earlier, in a more gradual fashion, and at times also reduce the maximum speed and/or the duration of time that the fan must spin at a given speed to remove the heat that will be generated by the system.

In an embodiment, an amount of power being consumed by the system is determined, e.g., from a power supply that measures incoming voltage and current (to give wattage), which may take into account the power efficiency rating of the power supply (e.g., for a laptop's external power supply). Consumption by the system of power derived from a battery pack and/or a commercial power supply may be determined. The power consumption data may be system total power consumption, a power consumption of a particular hardware element (or group thereof) or a particular application (or group thereof), or some combination of the foregoing.

This power consumption data may be converted to a heat value (e.g., BTUs) based on a known power-to-heat conversion calculation. In an embodiment, with a known value of the ambient temperature, e.g., as sensed by a thermistor placed to sense heat outside a system case, with a known volume inside the system case, and with a known capability of the fan(s) to remove air from the system case volume, the power consumption value may be utilized to determine fan setting(s) to proactively remove the heat from the system case prior to the heat being fully developed. This permits proactive control of heat generation prior to the heat being absorbed by system components (and sensed by thermistor(s)), which in turn leads to new opportunities to intelligently manage cooling of the system, e.g., with reduced acoustic impact. An embodiment therefore may utilize a power consumption value to proactively control cooling fan(s) such that the fans need not spin at high rates required once heat has fully developed within the system.

Additionally, an embodiment may take into consideration component material information (e.g., metal composition of certain hardware components) in order to more intelligently manage the cooling of the system. Certain components (e.g., metals) heat and cool in known ways that are different from other materials (e.g., plastics). Given this information, an embodiment may implement fan setting(s) that take into account not only power consumption of the system, but also apply knowledge of the material composition of hardware elements in proximity to certain fan(s). This allows an embodiment to proactively manage certain fan(s) such that their speeds are matched to the power consumption of the system as well as to the expected heating and cooling profile of particular hardware components. For example, rather than a fan quickly transitioning speed to react to a changed heat produced by a heat sink, the fan may be set to a certain, lower speed for a longer time in expectation that the heat sink will heat and cool in a repetitive fashion, e.g., based on the power consumption of the system. This again permits a more effective (e.g., efficient) cooling strategy to be employed, further reducing the acoustic impact of system cooling.

Furthermore, in an embodiment where multiple fans are controlled in a proactive fashion using power consumption value(s) and/or other data, as described herein, an embodiment may further act to coordinate the fans such that they offer noise cancellation. By way of example, proactive control of the fans allows the fans to be turned on or sped up earlier in anticipation of heat generation, thus allowing the fans to spin at lower rates or to spin within a broader range of speeds, thus in turn permitting one fan's timing and/or speed to act as a noise cancellation for another fan offering a dedicated cooling function.

In addition to reducing the noise that results from system cooling, an embodiment achieves better cooling of the system such that system components (e.g., processors, power supplies, etc.) are maintained at more optimal temperatures. This extends the lifespan of these components.

The illustrated example embodiments will be best understood by reference to the figures. The following description is intended only by way of example, and simply illustrates certain example embodiments.

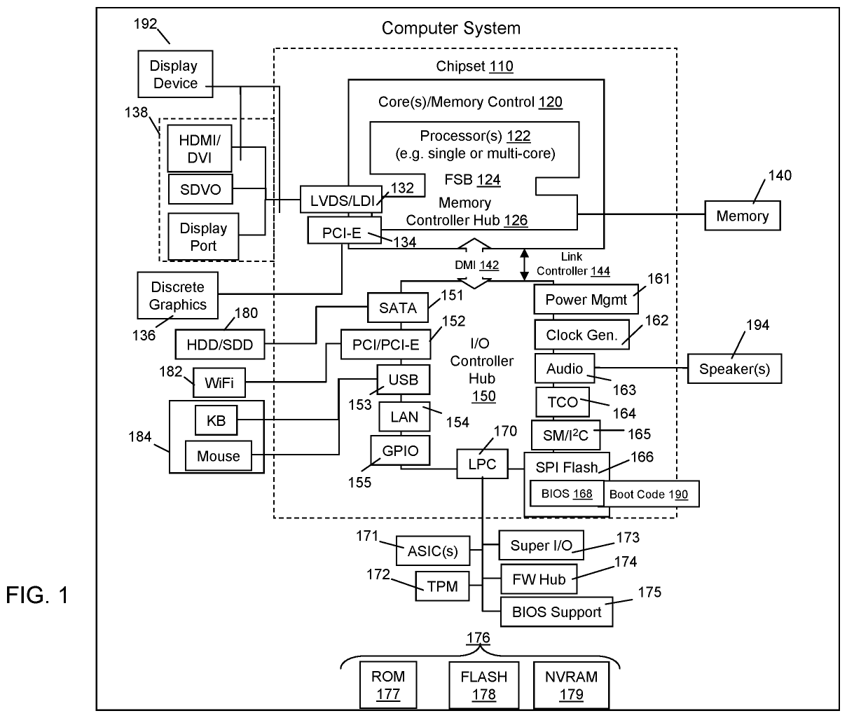

While various other circuits, circuitry or components may be utilized in information handling devices, FIG. 1 depicts a block diagram of an example of information handling or electronic device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 110 includes a core and memory control group 120 and an I/O controller hub 150 that exchanges information (for example, data, signals, commands, etc.) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture. One or more processors 122 comprise internal arithmetic units, registers, cache memory, busses, I/O ports, etc., as is well known in the art.

In FIG. 1, the memory controller hub 126 interfaces with memory 140 (for example, to provide support for a type of RAM that may be referred to as “system memory” or “memory”). The memory controller hub 126 further includes a low voltage differential signaling (LVDS) interface 132 for a display device 192 (for example, a CRT, a flat panel, touch screen, etc.). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, etc., 180), a PCI-E interface 152 (for example, for wireless connections 182), a USB interface 153 (for example, for devices 184 such as a digitizer, keyboard, mice, cameras, phones, microphones, storage, other connected devices, etc.), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling or electronic device circuitry, as for example outlined in FIG. 1, may be used in devices such as personal computers and/or other electronic devices which require cooling via fan(s). In an embodiment, a secondary chip (e.g., system I/O chip or hub controller 150 of FIG. 1, baseboard management controller in a server, etc.) may access the power consumption data (e.g., via querying a power supply, e.g., of an I²C bus) and control the fan speed(s) according to the various embodiments, as described herein. For example, a hardware monitoring functionality may be added to a system I/O chip such that power consumption data, as well as component material information, fan layout data, noise cancellation timing data, sensed heat data (inside the case and/or outside the case) is available and may be processed by the system I/O chip. Thus, an embodiment uses a system I/O chip or like component to proactively manage a control function for the fan(s) based on the power consumption data as well as any other data referenced herein.

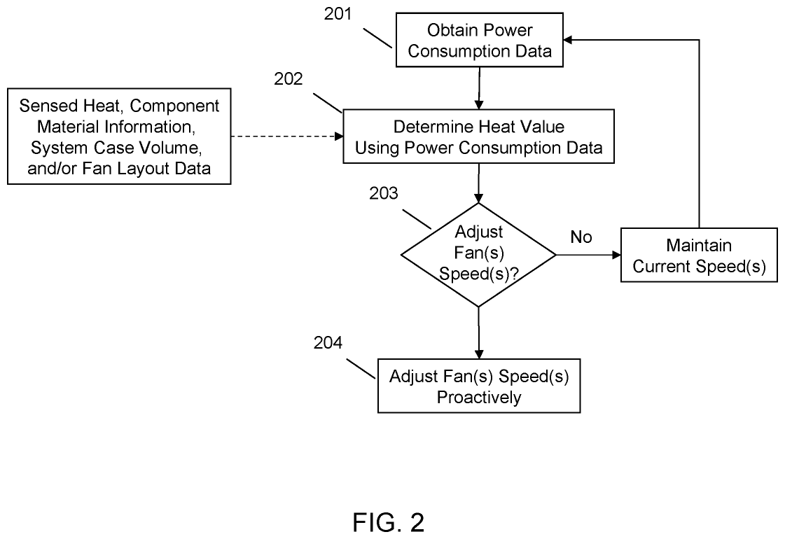

Referring now to FIG. 2, an embodiment achieves proactive control of device cooling by incorporating power consumption data into a cooling scheme, e.g., implemented by the aforementioned control function. As illustrated in the example of FIG. 2, an embodiment obtains power consumption data at 201. This power consumption data, as has been described herein, may include an overall system power consumption value (e.g., in watts), may include power consumption by discrete components (e.g., CPU, GPU, etc.) or a combination of the foregoing. As illustrated, an embodiment may determine a heat value at 202 using the power consumption data.

As illustrated, the heat value determined at 202 may be a simple calculation of system heat that is expected from the overall power consumed by the system. As will be appreciated by those having ordinary skill in the art, however, additional data may be available and put to use in optimizing or adjusting the control function and thus the operation of the fans or other cooling elements used to remove heat from the system in a proactive manner.

By way of example, and as illustrated in FIG. 2, sensed heat (e.g., from thermistors placed near the fans, placed to sense ambient temperature outside the system case, etc.) may provide useful data regarding how the power consumption will impact the heat produced inside the system case. Likewise, component material information (e.g., the material composition of certain hardware elements that produce and/or absorb heat), system case volume data (and thus the amount of heated air to be removed), fan layout data (which may include the space or location at which fans sit, along with proximate elements, as wells as fan size or functional information (e.g., how much airflow a fan can produce for a given speed)) may be obtained and used at 202 to determine an expected heat value based on the power consumption. It should be noted that an expected heat value may be a plurality of heat values, e.g., for different parts of the system.

Given this data, an embodiment uses the heat value to change or adjust a control function for controlling the fan(s). Thus, if it is determined that the current operation of the fan(s) should be adjusted, as illustrated at 203, an embodiment adjusts the fan(s) such that they rotate at a faster or slower rate, as shown at 204. In some situations, as has been described herein, the fans may be adjusted such that one fan cancels the noise of another. The fan(s) may be controlled such that they begin to remove heat in a proactive fashion, i.e., without waiting for sensors to detect heat production within the system. In many cases, this will lead to a slower rotational speed being required. Additionally, the fans may operate for a shorter period of time and in any event will provide a more effective cooling strategy to remove heat that will be generated by the power consumption within the system.

An embodiment uses a service processor, which is a separate dedicated internal processor and may be located on a motherboard, a PCI card, component, chassis of a platform or system, or the like. A service processor operates independently of the main processor (e.g., CPU) and operating system (OS), even if the CPU or OS is locked up or otherwise inaccessible. Typically, a service processor monitors a platform's or system's on board instrumentation (e.g., temperature sensors, CPU status, fan speed, voltages, etc.), provides remote reset or power-cycle capabilities, enables remote access to basic input/output system (BIOS) configuration or OS console information, and, in some cases, provides keyboard and mouse control. A service processor may also perform other functions.

In an embodiment, a system may use real electrical power measurements as input into the fan control. Acquiring such data may be accomplished in a couple different modalities. The overall system power consumption may be measured by sensors in the system power supply. Specifically, total system current may be measured and multiplied by the voltage to calculate the system's instantaneous power usage. Further, in an embodiment, power supplies typically have “rails”, or specific power distribution wiring (for example, one “rail” to CPUs, one “rail” to PCIe slots, one “rail” to graphics cards, etc.) In an additional embodiment, each rail's power may also be measured individually to understand which area or zone of the computer is consuming more power (and thereby producing more heat). Additionally, in an embodiment, the last modality may be measurement of specific components. For example, most modern CPU voltage regulators record the exact power they are delivering to the CPUs. Similarly, many high-end, high-power graphics adapters monitor their individual power consumption. In both cases, this power information may be captured in real-time for collection and processing.

In an embodiment, the information captured from the real-time power acquisition may then be fed back into an Embedded Controller (EC) or Super I/O (SIO)—the typical type of processing units which may be responsible for controlling the fans. Electrically, the EC or SIO may connect to the power supply/rails, CPU voltage regulator, graphics adapter, etc. by means of an I2C/SMBus, and may periodically query these devices every few hundred milliseconds to record the current power consumption. Using these datapoints, along with traditional inputs such as the thermal sensors, a fan control algorithm may be established within the EC/SIO which would provide more timely and more gradual fan speed increases.

For example, in an embodiment a high-computation workload may be scheduled on the system's CPU, and it jumps to 100% utilization. In a traditional closed-loop cooling algorithm, this may take 10-20 seconds before the sensors register a thermal spike, and the algorithm may have to respond with an abrupt and significant fan speed increase to dissipate the heat. This would likely result in noticeable acoustic change to the user. In the system described in this disclosure, the EC/eSIO may instead know within a few hundred milliseconds of the large power increase, and could begin to immediately and more gradually increase fans to support the heat dissipation. Likewise, once the computations were finished, and the workload reduced to idle, a more immediate action may be to gradually reduce the fans back to idle. Lastly, in this embodiment, by still having the traditional thermal sensors as inputs to this fan control algorithm, the system may have a “failsafe” to ensure that no extreme thermal conditions would ever occur in the event the algorithm failed to obtain or properly calculate the real electrical power measurements.

It should be noted, in an embodiment, one additional advantage of such a solution may be that by monitoring/collecting such power data, the EC/SIO may understand what the maximum power consumption may be for any given power rails or component. Knowing this may help bound the maximum fan speeds to speeds that may not be reached. Not having this data in a traditional system may mean that fans are often set fans at higher RPMs than may be actually necessary, translating to higher acoustics for the end user.

The various embodiments described herein thus represent a technical improvement to the process of cooling an electronic device by shifting from a reactive cooling scheme to a proactive cooling scheme. In order to accomplish this, an embodiment leverages power consumption data that may be incorporated into a fan control function such that the system may adapt more quickly to expected heat generating events. This reduces the acoustic impact on the device and extends the lifespan of device components by maintaining them within an optimal temperature range.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
obtaining, using at least one sensor, a value related to a current overall power consumption for an electronic device;
calculating, using a processor, a forecasted heat value calculated from the current overall power consumption, wherein the forecasted heat value indicates an expected value of heat for a region of the electronic device, wherein the calculating comprises correlating the current overall power consumption to a forecasted heat value; and
proactively cooling, based upon a fan control algorithm, the electronic device prior to a sensor detecting a temperature corresponding to the expected value of heat, wherein the proactively cooling comprises adjusting a speed of one or more fans located within the electronic device based on the calculated heat value.

2. The method of claim 1, wherein the obtaining a value comprises calculating the current overall power consumption from an obtained total system current value and voltage.

3. The method of claim 1, wherein the obtaining a value comprises obtaining a plurality of values, each of the plurality of values corresponding to a component within the electronic device.

4. The method of claim 1, further comprising sensing heat using a heat sensor;
wherein the adjusting takes into account the sensed heat.

5. The method of claim 4, wherein the heat sensor senses ambient temperature outside a casing of the electronic device.

6. The method of claim 1, wherein the value related to power consumption is derived from electronic device power consumption of a commercial power source.

7. The method of claim 1, further comprising obtaining component material information;
wherein the adjusting takes into account the component material information and a maximum heat value.

8. The method of claim 7, wherein the adjusting comprises adjusting a speed of one or more fans based on the determined thermal elements for each region and the component material information.

9. The method of claim 8, wherein:
the component material information comprises component material information for a component located proximately to the one or more fans; and
the cooling element is adjusted differently from another of the one or more fans based on the component material information.

10. The method of claim 1, wherein the adjusting comprises smoothing fan acceleration based on the heat value.

11. A device, comprising:
a fan that moves cooling air;
a processor operatively coupled to the fan;
a memory device that stores instructions executable by the processor to:
obtain, using at least one sensor, a value related to a current overall power consumption for an electronic device;
calculate, using a processor, a forecasted heat value calculated from the current overall power consumption, wherein the forecasted heat value indicates an expected value of heat for a region of the electronic device, wherein the calculating comprises correlating the current overall power consumption to a forecasted heat value; and
proactively cool, based upon a fan control algorithm, the electronic device prior to a sensor detecting a temperature corresponding to the expected value of heat, wherein the proactively cooling comprises adjusting a speed of one or more fans located within the electronic device based on the calculated heat value.

12. The device of claim 11, wherein the obtaining a value comprises calculating the current overall power consumption from an obtained total system current value and voltage.

13. The device of claim 11, wherein the obtaining a value comprises obtaining a plurality of values, each of the plurality of values corresponding to a component within the electronic device.

14. The device of claim 11, further comprising a heat sensor for sensing heat;
wherein the adjusting takes into account the sensed heat.

15. The device of claim 14, wherein the heat sensor senses ambient temperature outside a casing of the electronic device.

16. The device of claim 11, further comprising obtaining component material information;
wherein the adjusting takes into account the component material information and a maximum heat value.

17. The device of claim 16, wherein the adjusting comprises adjusting a speed of one or more fans based on the determined thermal elements for each region and the component material information.

18. The device of claim 17, wherein:
the component material information comprises component material information for a component located proximately to the one or more fans; and
the cooling element is adjusted differently from another of the one or more fans based on the component material information.

19. The device of claim 11, wherein the adjusting comprises smoothing fan acceleration based on the heat value.

20. A product, comprising:
a storage device having code stored therewith, the code being executable by a processor and comprising:
code that obtains, using at least one sensor, a value related to a current overall power consumption for an electronic device;
code that calculates, using a processor, a forecasted heat value calculated from the current overall power consumption, wherein the forecasted heat value indicates an expected value of heat for a region of the electronic device, wherein the calculating comprises correlating the current overall power consumption to a forecasted heat value; and
code that proactively cools, based upon a fan control algorithm, the electronic device prior to a sensor detecting a temperature corresponding to the expected value of heat, wherein the proactively cooling comprises adjusting a speed of one or more fans located within the electronic device based on the calculated heat value.
